(19) United States
(12) Patent Application Publication
(10) Pub. No.: US 2024/0344821 A1
(43) Pub. Date: Oct. 17, 2024

(54) USE OF A MEASURING UNIT FOR MEASURING DISTANCES IN A SHAFT ALIGNMENT SYSTEM

(71) Applicant: AKTIEBOLAGET SKF, GOTEBORG (SE)

(72) Inventors: Sylvain Georges Henri HUMBERT, Saizerais (FR); Brian Clifton Samuel JAGMOHAN, Etten-Leur (NL); Sebastien DAVID, Ouderkerk aan de Amstel (NL)

(21) Appl. No.: 18/625,588

(22) Filed: Apr. 3, 2024

(30) Foreign Application Priority Data
Apr. 12, 2023 (DE) 102023203326.7

(51) Int. Cl. G01B 11/00; G01B 21/04; G01M 13/02

(52) U.S. Cl. CPC G01B 11/005; G01B 21/047; G01M 13/02

(57) ABSTRACT

A method for determining distance between a measuring unit and a point of a first machine when performing a process of aligning the shafts of the first machine and a second machine includes a step of securing the measuring unit to one of the shafts. The method further includes the steps of determining the length of a segment between the measuring unit and a reference surface of the first machine and calculating the distance between the measuring unit and the point of the first machine from the determined length of the segment and a predetermined dimension between the reference surface and the point of the first machine.

### CROSS-REFERENCE

This application claims priority to German patent application no. 102023203326.7 filed on Apr. 12, 2023, the contents of which are fully incorporated herein by reference.

### BACKGROUND OF THE INVENTION

The present invention relates to measuring systems, and more particularly to a method for determining distances between a measuring unit and one or more points on a machine when performing a process of alignment of shafts of a first machine and a second machine. Such a method may be implemented with a shaft alignment tool utilizing a tablet and/or smart phone or similar device.

With a power transmission between rotary shafts, for example via coupling, a first shaft may be part of a first machine, such as a motor, and a second shaft may be part of a second machine, such as a pump, a fan, a gear box, or any other appropriate type of machine. As such, the first shaft is a drive shaft and the second shaft is a driven shaft.

A major part of keeping machinery running smoothly involves regular maintenance, upkeep and ensuring that the machinery is sufficiently lubricated and properly aligned. Correct alignment of the connected shafts ensures smooth, efficient transmission of power from the first machine to the second machine.

However, when the first and second shafts of rotating machinery are misaligned, the risk of costly, unplanned machine downtime rises dramatically. Failure to properly align the two shafts increases the amount of stress on the units, resulting in a range of potential problems that may ultimately have a serious impact on a company's bottom line. Shaft misalignment is responsible for as much as fifty percent of all costs related to machinery breakdown.

Shaft misalignment also increases friction, resulting in excessive wear, excessive energy consumption, and the possibility of premature breakdown of machinery. Misalignment also causes excessive wear on bearings and seals, which also leads to premature failure. Further, shaft misalignment may also lead to premature shaft and coupling failure, excessive seal lubricant leakage, failure of coupling and foundation bolts, and increased vibration and noise.

Basically, shaft misalignment occurs when the axes of the first and second shafts are not in line or collinear with each other. Such misalignment may be due to parallel or angular misalignment or a combination of both. With parallel misalignment, the axes of the two shafts run parallel to each other, but are offset. With angular misalignment, the shafts extend at an angle to one another or are skew.

Accordingly, proper shaft alignment is one of the most important factors influencing rotating equipment performance. Shaft alignment eliminates or at least reduces the risk of breakdowns, reduces unplanned downtime and corresponding loss of production, and minimizes maintenance costs.

Machines need to be aligned in both horizontal and vertical planes. When performing shaft alignment, different processes may be used. Three such processes involve a visual inspection combined with a straightedge or ruler, the use of dial indicators, or the use of laser guided tools.

The conventional process including visual inspection combined with a straightedge or ruler is still in common use. A straightedge is positioned on two bearings supporting one or more shafts while a maintenance inspector visually assesses whether or not the components are properly aligned. Such a rough process has the advantage of being quick and relatively easy.

Dial indicators are implemented in another conventional process of measuring misalignment. Dial indicators provide a higher degree of accuracy in comparison to visual inspection with a straightedge.

The process of using laser-guided tools is quick, accurate and easy to use. In addition, such a process delivers consistently better accuracy than dial indicators and does not require special skills to obtain accurate results virtually every time. Shaft alignment laser guided tools typically consist of two units, each capable of emitting a precise laser beam and detecting a laser beam from the other unit, and a handheld control device.

Laser alignment processes provide a marked improvement in accuracy compared to the other conventional processes. Also, a laser-driven shaft alignment device allows an operator to adjust shaft alignment with far more speed and accuracy than either the straightedge or dial process.

Whichever one of the above processes is used, shims must typically be inserted below one or more feet of at least one of the two machines to align the shafts with respect to each other. In practice, a user loosens the retaining screws of the feet, lifts a machine by a few millimeters, inserts shims under the feet, and then retightens the screws. After installation of the shims, another alignment measurement is usually taken to ensure the job has been properly performed.

The foregoing alignment processes usually provide good results, but still have some drawbacks. One drawback is that the shafts are sometimes not correctly aligned after the installation of the shims according to the recommended thicknesses. In other words, despite the precision of measurement achieved by the different processes of shaft alignment, and despite the precision of the calculations based on these measurements, misalignments may remain.

Another drawback is the loss of time. That is, adjusting the alignment at least twice takes a relatively substantial amount of time.

### SUMMARY OF THE INVENTION

In view of the foregoing, one object of the present invention is to achieve proper alignment the first time since it is, of course, better not to do the same work twice. Another object of the present invention is to improve alignment accuracy. An additional object of the present invention is to save time involved in the alignment processes.

The above mentioned objects are achieved by the preferred embodiment of the present invention, which is a method for determining distance between a measuring unit and one or more points of a first machine when performing a process of alignment of the shafts of the first machine and a second machine. The method includes the steps of securing the measuring unit to one of the two shafts, determining the length of a segment between the measuring unit and a reference surface of the first machine, and calculating the distance between the measuring unit and the point of the first machine from the determined length of the segment and a predetermined dimension between the reference surface and the point of the first machine.

The reference surface can be a flange, which provides a flat surface area perpendicular to the shaft. In such a case, the length of the segment is between the measuring unit and the flange. Because the reference surface is regular, the segment is accurately measured.

Manufacturing dimensions are characteristics which generally conform to standards and are available in catalogues, databases, handheld control devices, or other known sources of such information. For example, when a machine is an electric motor, standard manufacturing dimensions are typically provided by reference materials such as a product manual. The provided dimensions typically include the transverse distance between the feet, the longitudinal distance between the feet, the distance between the axis of the shaft and the base, shaft diameter, outside shaft length, the distance between the shaft side flange and front feet, the distance between the shaft side flange and back feet, etc.

When performing a shaft alignment, a provided standard dimension of the machine does not need to be measured. The availability of such information is significant because, when the machine is installed and ready to operate, certain parts of the machine may be difficult to access for direct measurement. As such, use of normalized or standard manufacturing dimensions reduces the risks of error when performing a shaft alignment. Due to such provided manufacturing dimension(s), it becomes relatively easy to calculate distances between a measuring unit and a certain point or points on a machine.

For example, the distance between a measuring unit and a front foot of a machine may be obtained by adding the length of a segment between the unit and the flange to the normalized or standard distance between the flange and the foot. The paradox is that the precision of localization of the foot compared to the measuring unit is increased, even though two values are combined.

It follows from the above discussion that those calculations correlated to the alignment process are more pertinent. As such, measured misalignments better reflect reality or the actual misalignment of the shafts. In practice, reducing the number of required measurements reduces the risk of error. As a result, the probability of a correct adjustment on a first attempt is increased. One advantage that derives from the present method is that, in most cases, the alignment process is accurate the first time it is conducted. As such, there is no need to redo the alignment work and no time is wasted.

In a preferred embodiment of the present method, the reference surface of the first machine is a shaft side flange, a reflective panel being arranged on the shaft side flange, the length of the segment being the sum of the axial space or axial distance between the measuring unit and the panel plus the axial thickness of the panel. Due to its reflective properties, the panel ensures that the signal emitted by the measuring unit, for example pulsed light, is perfectly returned to the measuring unit. In other words, the panel guarantees the measurement accuracy. Then, the length of the segment is calculated by adding the axial space/distance between the unit and the panel and the panel thickness. The precision of the method is thus preserved.

In a variant of the present method, the reference surface of the first machine is the shaft side flange, the length of the segment being the axial space/axial distance between the measuring unit and the shaft side flange. In this case, the method works very well when the surface of the flange reflects light, for example, when the surface of the flange is precision machined so as to be reflective. In such a case, the reflective panel is not needed.

In general, when practicing the present method, one measuring unit is secured to the shaft of the first machine and another measuring unit is secured to the shaft of the second machine. In most cases, each measuring unit is used independently of the other to obtain the necessary distances, which helps to simplify the alignment process.

The first machine may be an electric motor, and in most cases, such a machine meets specified manufacturing standards. With the motor reference, it is easy to find necessary dimensions of the machine as such dimensions are available in catalogues, databases, handheld control devices, or other reference materials or devices. As a result, obtaining a distance between a measuring unit and a specific point on the machine is relatively quick and easy.

In some cases, the point is a front foot of the machine. Using standard data is much more reliable than using a measuring device, such as a roll meter. In other cases, the point is a back foot. In such cases, using standard data is again much more reliable than using, for example, a roll meter or other measuring device.

Often the required calculation is an addition or summation. In particular, determining the distance between a measuring unit and a foot when the reference surface is a flange is very simple.

The calculation may be made with the help of an algorithm, which is quick and reliable. Further, the algorithm may be used for the entire alignment process. The algorithm calculates the shaft misalignment of machines. Because the preparatory measurements have been improved with the method, the calculation of misalignment is more accurate and more reliable.

Preferably, the measuring unit operates by pulsed light. This technology, which is very well known in the measurement industry, is easy to implement. The pulsed light may be a laser, and such a pulsed light is very precise and reliable.

Due to the present invention, complicated and time-consuming alignment processes of the prior art have been changed to a simple and quick process.

### BRIEF DESCRIPTION OF THE SEVERAL VIEWS OF THE DRAWINGS

In the following, the invention will be described in greater detail with reference to a non-limiting embodiment shown in attached drawing, in which:

FIG. 1 is a top plan view of a shaft alignment system according to one embodiment of the invention.

### DETAILED DESCRIPTION OF THE INVENTION

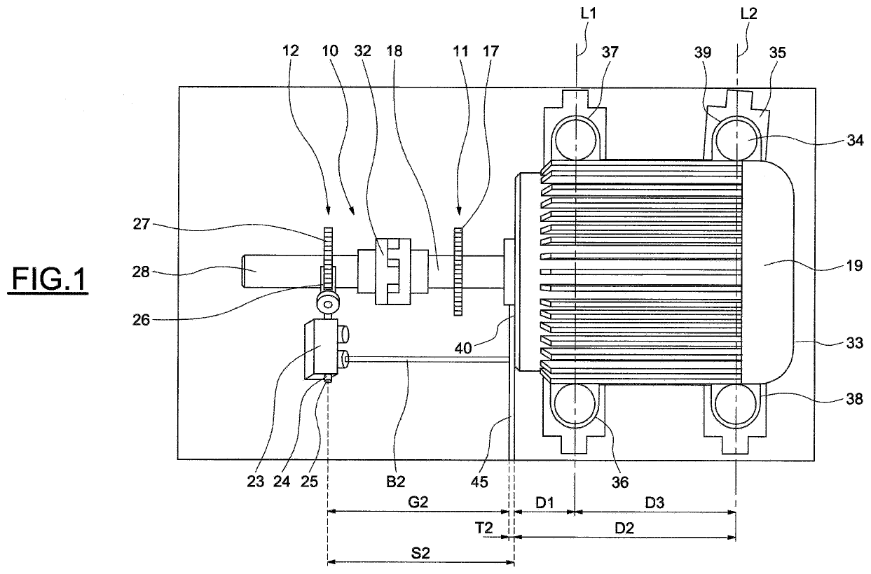

FIG. 1 shows a preferred embodiment of a shaft alignment system 10 used for the implementation of a method according to the present invention. The shaft alignment system 10 comprises a first measuring unit 11, which is partially shown, and a second measuring unit 12, shown in its entirety.

By way of a non-limiting example, the first measuring unit 11 preferably includes a main part (not shown), two connecting rods (neither shown), a bracket 16 and a chain 17. In a known manner, the bracket 16 and the chain 17 are removably attached to a shaft 18 of a first machine, which is depicted as an electric motor 19. As such, the shaft 18 is a drive shaft. Preferably, the two rods are secured to the bracket 16 and the main part is secured to the rods. This structure allows precise and stable positioning of the main part in relation to shaft 18. Alternatively, other fastening means may be used to secure the main part to the shaft 18.

Similarly, the second measuring unit 12 includes a main part 23, two connecting rods 24, 25, a bracket 26 and a chain 27. The bracket 26 and the chain 27 are removably attached to a shaft 28 of a second machine (not shown), such as for example, a pump, a fan, a gear box, or a similar machine. As such, the shaft 28 is a driven shaft. The rods 24, 25 are secured to the bracket 26 and the main part 23 is secured to the rods 24, 25. Although there are preferably two rods 24, 25, only one is visible in FIG. 1 as one rod hides the other rod. This structure provides precise and stable positioning of the main part 23 in relation to the shaft 28. As with the first measuring unit 11, other fastening means may be used to secure the main part 23 to the shaft 28.

The shaft 18 of the motor 19 and the shaft 28 of the driven machine are connected to each other by means of a coupling joint 32. The joint 32 is used to transmit power and torque between the two shafts 18, 28.

In a non-limiting way, the present method is described in detail below with reference to the second measuring unit 12, but equally applies to the first measuring unit 11.

As shown in FIG. 1, the second measuring unit 12 emits a laser beam B2 and detects the laser beam at its main part 23. Such laser technology is easy to use and can be implemented with calculation devices using an algorithm.

The motor 19 is held in a stable position on a base 33 by means of screws 34 and washers (not shown). Other attachment means may alternatively be used, but screws and washers are economical and easy to implement. Preferably, adjustment of the position of the motor 19 relative to the base 33 is made by means of shims 35. Other position adjustment means may alternatively be used, but shims are economical and easy to implement. In the same spirit, while not shown in FIG. 1, the machine comprising the driven shaft 28 is preferably held in a stable position on the base 33 by means of screws and washers. The adjustment of the position of the machine relative to the base 33 may be also made by means of shims.

Preferably, the motor 19 has two front feet 36, 37 and two back feet 38, 39. The two front feet 36, 37 are aligned along a straight line L1 perpendicular to the shaft 18, and the two back feet 38, 39 are aligned along a straight line L2 also perpendicular to the shaft 18. Consequently, two screws 34 are aligned on the line L1 and two screws 34 are aligned on the line L2.

The alignment of the shaft 18 of the first machine 19 and the shaft 28 of the second machine 19 requires knowledge of the actual distances between each measuring unit 11, 12 and one or more particular points on at least one of the machines, such as each front foot 36, 37 and/or each back foot 38, 39.

One step of the present method consists of determining the length of a segment S2 between the measuring unit 12 and a reference surface 40 of the motor 19. In a non-limiting way, the reference surface 40 is the shaft side flange of the motor 19. As such, the reference surface 40 is flat and perpendicular to the shaft 18. Moreover, the surface state of the flange 40 has a low roughness.

A reflective panel 45 may be arranged on the shaft side flange 40. Such an arrangement may be accomplished by manually retaining the panel 45 on the flange 40 (i.e., hand held), but alternatively, a holding device may be used. Then, the measuring unit 12, due to the main part 23, determines the axial space or distance G2 between the unit 12 and the panel 45. The axial thickness T2 of the panel 45 is known or is measured before or after the determination of the axial space/distance G2. The length of the segment S2 is determined by summing or adding the axial space G2 and the axial thickness T2. The length of the segment S2 is known very precisely because the laser of measuring unit 12 gives very precise results or measurements, and because precise measurement of panel 45 is easy to do. The precision of the step of determining the length of the segment S2 is increased due to the measurement being made parallel to the shaft 28. Further, the addition or summation of the axial space or distance G2 plus the axial thickness T2 can be done by mental computation, manually (i.e., calculated on paper), with a calculator, by means of an algorithm, or by other known means.

Another step of the present method consists in considering the manufacturing dimensions between the reference surface 40 and a point of the motor 19. For example, the dimension may be the distance D1 between the flange 40 and a front foot 36 or 37, or the distance D2 between the flange 40 and a back foot 38 or 39. Since the distance D3 between each front foot 36, 37 and the adjacent one of the back feet 38, 39, respectively, is a manufacturing dimension, D2 can be obtained by summing or adding D1 and D3.

Then, a further step of the present method consists in making a calculation considering or using the segment S2 and a manufacturing dimension such as D1, D2 and/or D3. Adding S2 and D1 gives the distance between the measuring unit 12 and a front foot 36 or 37. Adding S2 and D2 gives the distance between the measuring unit 12 and a back foot 38 or 39. Adding S2, D1 and D3 also gives the distance between the measuring unit 12 and a back foot 38 or 39.

As discussed above, the present method is also implemented or utilized for the first measuring unit 11. It is then possible to consider all necessary distances to perform the process of alignment of shafts 18, 28. To do this, in a known manner, the two measuring units 11, 12 are respectively mounted on each shaft 18, 28, respectively. Preferably, the distances given by the present method are provided or inputted to an algorithm by any appropriate means. For example, distances may be provided at an interface of a computer, a tablet, a smartphone, or the like.

Then, a process of alignment of the shafts 18, 28 may be followed, such an alignment process being known per se and therefore not described herein.

By using the method according to the present invention, the alignment process provides more accurate misalignment values. The two shafts 18, 28 are preferably rotated to different positions to allow the measuring units 11, 12 to provide or determine a variety of different values. Then, the algorithm may give height corrections to be made to each foot 36, 37, 38, 39, and the right shim thicknesses can be selected.

In addition, the algorithm may document the values described above, which can be used as a benchmark for future alignment inspections. The algorithm may be designed to come with a built-in step-by-step alignment process, from preparation, inspection, and evaluation through correction, reporting and analysis. Further, a database may be provided to store data regarding visual inspections of oil leakage, oil level, foundation bolt status, and wear indications.

While a preferred embodiment has been described, according to the present invention, it is realized that variations and modifications within the scope of the attached claims may exist. For example, the reference surface could be the flange on the side opposite to the shaft. In this case, the calculation would be a subtraction operation instead of an addition or summation. Further, the present invention may advantageously be used in all applications where two shafts must be aligned plane-parallel or essentially plane-parallel.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A method of determining the distance between a measuring unit and a point of a first machine when performing a process of alignment of a shaft of a first machine and a shaft of a second machine, the method comprising the steps of:
securing the measuring unit to the shaft of the first machine or the shaft of the second machine;
determining a length of a segment between the measuring unit and a reference surface of the first machine; and
calculating a distance between the measuring unit and the point of the first machine from the determined length of the segment and a predetermined dimension between the reference surface and the point of the first machine.

2. The method according to claim 1, wherein the reference surface of the first machine is a shaft side flange, a reflective panel being arranged on the shaft side flange, the length of the segment being the sum of an axial distance between the measuring unit and the panel and an axial thickness of the panel.

3. The method according to claim 1, wherein the reference surface of the first machine is a shaft side flange, the length of the segment being an axial distance between the measuring unit and the shaft side flange.

4. The method according to claim 1, wherein the measuring unit is secured to the shaft of the first machine and another measuring unit is secured to the shaft of the second machine.

5. The method according to claim 1, wherein the first machine is an electric motor.

6. The method according to claim 1, wherein the point is a front foot.

7. The method according to claim 1, wherein the point is a back foot.

8. The method according to claim 1, wherein the calculation includes a summation.

9. The method according to claim 1, wherein the calculation includes an algorithm.

10. The method according to claim 1, wherein the measuring unit operates by pulsed light.

11. The method according to claim 10, wherein the pulsed light is a laser.
